(19) United States
(12) Patent Application Publication
(10) Pub. No.: US 2024/0430217 A1
(43) Pub. Date: Dec. 26, 2024

(54) Method and System for Establishing a Globally Open Voice-Enabled, Interoperable Chatbot System Referencing WWW Structures

(71) Applicant: Jianwen Zhao, Naperville, IL (US)

(72) Inventor: Jianwen Zhao, Naperville, IL (US)

(21) Appl. No.: 18/750,677

(22) Filed: Jun. 21, 2024

Related U.S. Application Data
(60) Provisional application No. 63/509,428, filed on Jun. 21, 2023.

(51) Int. Cl. H04L 51/02; G10L 15/22

(52) U.S. Cl. CPC H04L 51/02; G10L 15/22

(57) ABSTRACT

A system for enabling users to interact with various open chatbots and other resources using a special internet browser or browser plugins. The system includes a global chatbot registry for registering and managing open chatbots, open chatbots, open chatbot browser, open chatbot search engine, and protocols. The system enables users to interact with various chatbots and other resources using a special internet browser or browser plugins installed on any computer, phone, wearable devices or a voice first smart device.

### FIELD OF INVENTION

The present disclosure generally relates to the field of Internet. More specifically, the present disclosure relates to a Method and System for Establishing a Global Voice-Enabled Chatbot Network Referencing WWW Structures.

### BACKGROUND OF THE INVENTION

The World Wide Web, as conceived by Tim Berners-Lee, rests upon three foundational pillars: the Uniform Resource Locator (URL), Hypertext Transfer Protocol (HTTP), and Hypertext Markup Language (HTML). These innovative components ushered in the era of PC internet and Graphic User Interfaces (GUIs or “screens”). Presently, we are amid a significant transition towards the Internet of Things (IoT) and the age of conversational internet.

Transitioning from traditional screens and keyboards towards Conversational User Interfaces (CUIs) in IoT devices, we face pressing questions: How will we browse the web without keyboards? How can websites convert into voice-friendly platforms? How can we efficiently access chatbots by their names, like visiting websites? Should we rely on a handful of centralized proprietary companies to register and manage chatbots via their Lower Layer Middleware (LLM)? These issues suggest the conventional web may fall short in meeting future requirements.

In response to evolving devices, interfaces, protocols, and behaviors, it's crucial we reform the foundational structures of the WWW. Otherwise, we risk amplifying tech giants' control over the web and undermining its open character. Big tech is leading the development of proprietary smart speakers, which will soon need to interface with billions of devices. This imminent requirement highlights the need for a decentralized standard, the Voiceweb. Smart speakers, increasingly activated by voice to access chatbot services, are predicted to become the primary internet access points. Yet, these services are constrained by each speaker manufacturer's standards, resulting in potential name conflicts, user inconvenience, and limited chatbot accessibility. Interoperability across new smart speakers requires complex, mixed coding efforts, further complicated by the fact that naming systems established by companies like Google and Amazon are closed and proprietary.

To navigate this voice-centric era, we propose a decentralized invocation-name scheme, aiming to enrich WWW's spirit, benefit internet users, and curtail monopolization. Voiceweb, while ambitious, is both necessary and timely. It targets the current bottleneck in the Voice Internet and IoT industry.

### SUMMARY OF THE INVENTION

A system for enabling users to interact with various open chatbots and other resources using a special internet browser or browser plugins. The system includes a global chatbot registry for registering and managing open chatbots, open chatbots, open chatbot browser, open chatbot search engine, and protocols. The system enables users to interact with various chatbots and other resources using a special internet browser or browser plugins installed on any computer, phone, wearable devices, or a voice first smart device. The system includes the following components:
A global open chatbot registry for registering and managing chatbots. The global chatbot registry can store metadata related to each chatbot, including chatbot name, description, and URL address. Chatbot platforms and services that are compatible with the Chatbot Communication Protocol and can be accessed through the Chatbot browser.
Open Chatbot which is built and published by developers. The Open Chatbot could be built by the developers themselves, or built on the open chatbot builder platform, which provide a variety of tools and resources for chatbot development, including development frameworks, libraries, and testing tools.
Open chatbot browsers. A browser that allows users to interact with open chatbots using voice commands, text input, and multimedia content. The browser should include rendering support for multimedia messages and should be compatible with various smart IoT devices. This part is used to locate the address of a chatbot by querying its name on the global open chatbot registry. If the browser is installed in any voice first devices, it should support voice commands. If the browser is installed on a voice first device, it should facilitate voice utterance natural language-based searches of chatbots and other resources. The voice search engine can use natural language processing techniques to analyze and interpret user voice commands and can query various databases and resources to find the most relevant chatbots and other resources based on the user's voice command. To make the browser decentralized, it will interpret the natural language using local integrated LLMs, not remotely.
A collection of protocols, including. A) A chatbot communication protocol for facilitating communication between the chatbot browser and chatbots. The chatbot communication protocol can support multiple chatbot APIs and can adapt to new APIs as they are developed. B) Hyper link protocol. The chatbots can be hyper linked. C) Chatbot Name Resolving protocol.

The proposed architecture aims to provide a seamless and unified way for users to interact with various chatbots using a single chatbot browser. By connecting the Global Chatbot Registry with the Chatbot Name Resolving Protocol and the Chatbot browser, users can easily discover and interact with chatbots across different platforms and services. The system can enhance user experience by providing a convenient and intuitive way to interact with various chatbots and other resources using a chatbot browser. The system can also improve the discoverability of chatbots and other resources by making them easily searchable using natural language commands.

### BRIEF DESCRIPTION OF THE DRAWINGS

FIG. 1 is a block diagram of the present invention.

FIG. 2 is a flowchart of the present invention.

FIG. 3 is a block diagram of the present invention.

FIG. 4 is a flowchart of the present invention.

FIG. 5 is a flowchart of the present invention.

FIG. 6 is a block diagram of the present invention.

FIG. 7 is a block diagram of the present invention.

FIG. 8 is a block diagram of the present invention.

FIG. 9 is a block diagram of the present invention.

FIG. 10 is a block diagram of the present invention.

### DETAILED DESCRIPTION OF THE INVENTION

All illustrations of the drawings are for the purpose of describing selected versions of the present invention and are not intended to limit the scope of the present invention.

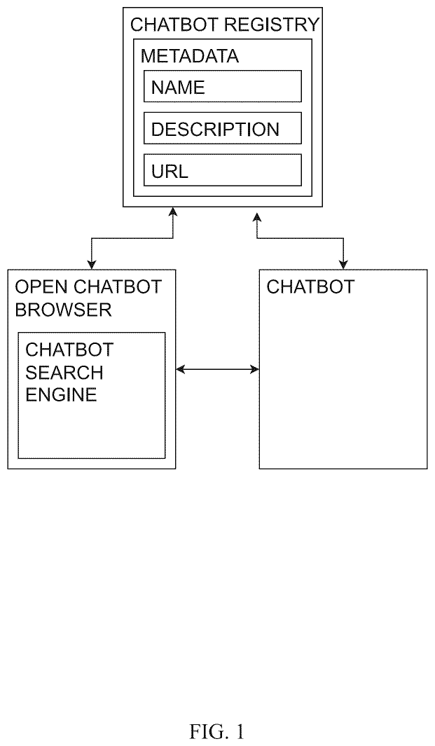

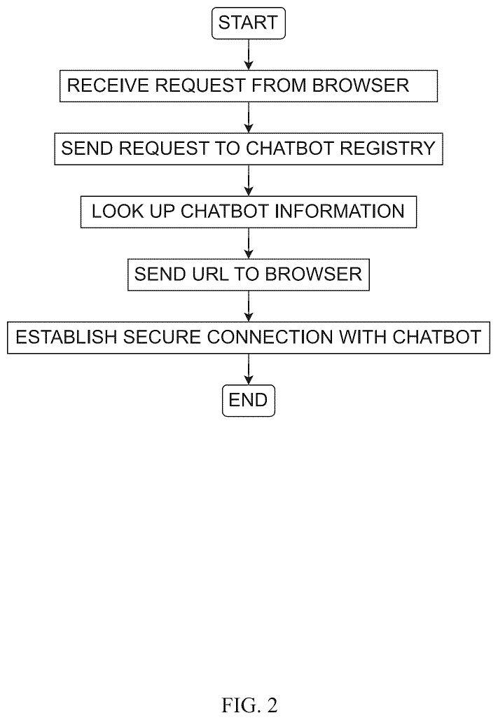

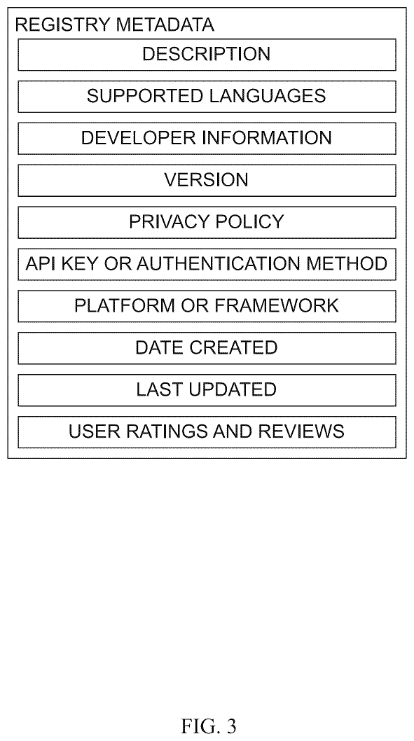

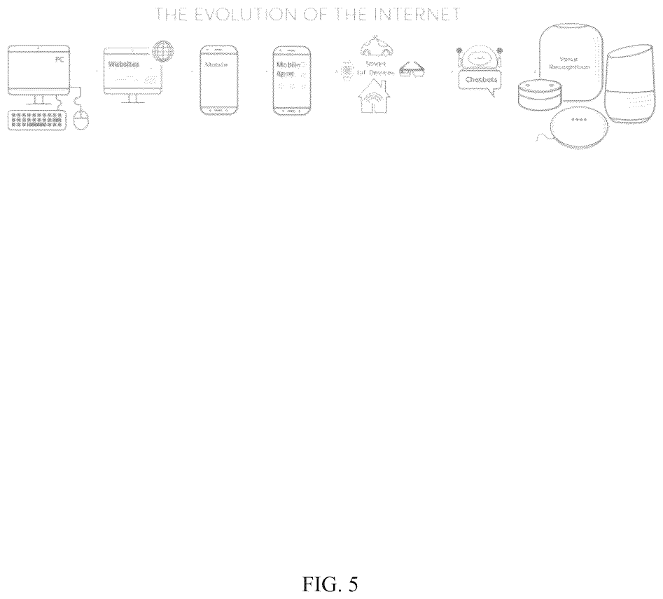

Referring to FIGS. 1-10, the present invention comprises a number of modules.

### Module 1-Open Chatbots

A system for providing open chatbots that can be accessed and interacted with using a global chatbot registry and a chatbot communication protocol. The open chatbots can be developed and registered by anyone and can be used by users via chatbot browsers.

The open chatbots system allows anyone to develop and register a chatbot with the global chatbot registry. The chatbots can be developed using any suitable chatbot development framework or tool, and can be registered by providing the chatbot name, description, and endpoint URL or IP address to the global chatbot registry.

The global chatbot registry maintains a database of registered chatbots and their endpoint URL or Ips. The chatbot communication protocol is used by chatbot browsers to interact with open chatbots. The chatbot communication protocol defines the format and structure of messages exchanged between the chatbot browser and the chatbot and enables the chatbot browser to retrieve responses and redirect to other chatbots.

The open chatbots system promotes innovation and creativity by allowing anyone to develop and register a chatbot, usually without the need for approval or authorization from a central authority. The open chatbots system also enhances user experience by providing a diverse range of chatbots that can be accessed using voice commands via chatbot browsers.

### Module 2-Global Chatbot Registry

A global chatbot registry system and method for registering and mapping chatbot names to chatbot IP address or URLs. The system includes a decentralized distributed system (which could be blockchain, tangle, or Bind like system) for storing chatbot name and IP/URL mappings, and a registration process for chatbot developers to register their chatbots with the registry. The registry system enables chatbot browsers to redirect user requests for a chatbot by name to the correct chatbot IP address/URL address.

The global chatbot registry system and method is a decentralized system for mapping chatbot names to chatbot IP Address or URLs. The system includes a open ledger for storing chatbot name and IP/URL mappings, which is distributed among nodes in the network. The system enables chatbot developers to register their chatbots with the registry by providing the chatbot name, chatbot IP Address or URL, and other relevant information.

The registration process includes verifying the authenticity and ownership of the chatbot by the developer, and then adding the chatbot to the registry database. The system also includes a search function for users to search for registered chatbots by name, and a redirection function for chatbot browsers to redirect user requests for a chatbot by name to the correct chatbot URL address.

To address this issue, we can create a global Chatbot Registry System that manages the mapping of chatbot names to their corresponding URLs. This system can provide a cloud-based service with APIs that allows chatbot developers to register, update, or remove their chatbots from the registry. The system would include a ledger to store the chatbot name and URL mappings, along with any relevant metadata.

Here's an overview of the Chatbot Registry System and its components:
Chatbot Registry API: This API allows chatbot developers or chatbot name Agents to interact with the Chatbot Registry System. It should support operations such as registering a new chatbot, updating an existing chatbot's information, and removing a chatbot from the registry.2)
Chatbot Registry Ledger: This is the storage component that holds the chatbot name and IP/URL mappings, along with any additional metadata, such as descriptions, supported languages, or tags. This can be a cloud-based database service like Amazon RDS, Google Cloud SQL, or Microsoft Azure SQL Database, ensuring high availability and scalability.
Chatbot Lookup API: This API is used by the Chatbot browser's Chatbot Management Module to query the Chatbot Registry System for a chatbot's URL/IP based on its name. When the user provides a chatbot name, this API is called to retrieve the corresponding URL and establish a connection with the chatbot.
Here is a high-level chart illustrating the interaction between the Chatbot browser and the Chatbot Registry System:

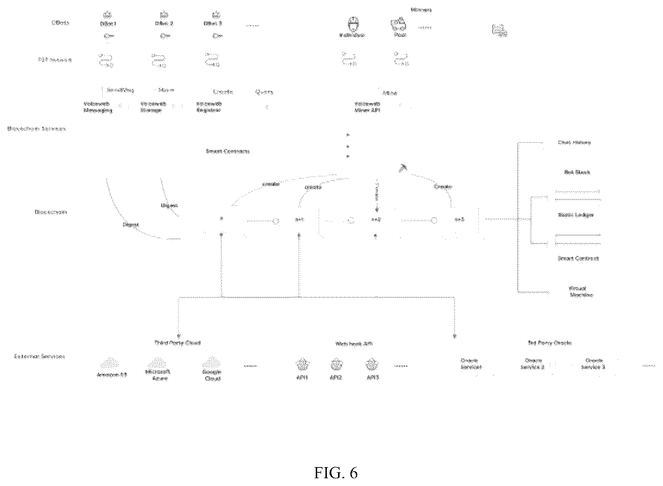

FIG. 6 shows an example implementation of the global registry.

### 2.1 Registry Meta Data on the Ledger

In addition to the chatbot name and URL address, the Chatbot Registry System can store several other metadata elements that can provide valuable information about the chatbot and enhance the user experience. Some of these metadata elements may include the following:
Description: A brief description of the chatbot's purpose, functionality, and target audience can help users understand what the chatbot offers and whether it meets their needs.
Supported Languages: Information about the languages supported by the chatbot can help users find chatbots that can interact with them in their preferred language.
Tags or Categories: Adding tags or categories can make it easier for users to search and discover chatbots based on specific topics, industries, or functionalities.
Developer Information: Including the name of the developer or company responsible for the chatbot, along with contact information, can provide users with a point of contact for support or feedback.
Version: Storing the current version of the chatbot can help users and developers keep track of updates and improvements.
Privacy Policy and Terms of Service: Providing links to the chatbot's privacy policy and terms of service can inform users about how their data is handled and any usage restrictions.
API Key or Authentication Method: If the chatbot requires an API key or any form of authentication for access, this information should be stored in the registry.
Platform or Framework: Storing information about the chatbot's platform or framework (e.g., Rasa, Dialog flow, or a custom-built solution) can help developers and users understand the underlying technology.
Date Created and Last Updated: Recording the creation date and last update date of the chatbot can give users an idea of the chatbot's age and maintenance status.
User Ratings and Reviews: Allowing users to rate and review chatbots can provide valuable feedback to developers and help potential users make informed decisions about which chatbots to use.

These metadata elements can enhance the functionality of the Chatbot Registry System by providing users with more context and information about the chatbots, improving discoverability and user experience. Usually, in an advanced distributed system, the meta information is usually stored in the form of smart contract.

### 2.2 Naming Rules

To avoid confusion and potential misdirection due to similar sounding chatbot names in the Global Chatbot Registry, the system is scalable to implement a set of naming rules and guidelines for users to follow. Here are some examples:
Unique prefixes/suffixes: Encourage chatbot developers to use unique prefixes or suffixes in their chatbot names to distinguish them from others.
Use of clear, distinct words: Encourage the use of clear and distinct words or phrases that are easy to understand and differentiate when pronounced.
Name length and complexity: Limit the length and complexity of chatbot names to reduce the chances of confusion. Shorter and simpler names are easier to remember and less prone to misunderstandings.
Avoid homophones: Discourage the use of chatbot names that are homophones (words that sound the same but have different meanings) or names that have similar pronunciation to existing chatbot names.
Namespace separation: Implement a namespace system for chatbot names, similar to the hierarchical structure of domain names. For example, “[category] [chatbot name]” or “[company name] [chatbot name]” This can help create a more organized naming structure and minimize confusion.
Name validation and approval: Implement a name validation and approval process that checks for potential conflicts or similarities with existing chatbot names before allowing new chatbot registrations. This can help prevent issues before they occur.
Phonetic dissimilarity check: Develop an algorithm that checks for phonetic similarity between chatbot names during registration. This could help in identifying and preventing the registration of chatbot names that sound too similar to existing ones.

By following these guidelines and rules, you can help minimize confusion and potential misdirection due to similar sounding chatbot names in the Global Chatbot Registry, creating a better user experience and ensuring smooth voice interactions.

### 2.3 Legal and Claims

The mechanism about conflicts between the open ledger involves querying both the traditional DNS and trademark databases, as well as utilizing a decentralized autonomous organization (DAO) to resolve disputes. Here are the key points of this process:

Trademark Query: When a user wants to register a trademark as a domain, the system queries both the trademark database and traditional DNS systems to check if the name already exists.
Pending Period: If the name exists, a pending period is initiated. During this time, existing trademark holders or domain name owners have an opportunity to claim the domain.
Claim Resolution: If multiple claims arise during the pending period, the DAO associated with the decentralized DNS chain will intervene to determine the rightful owner. The DAO may use pre-defined rules or allow the community to vote on the outcome.
Successful Registration: If no claims are made during the pending period, the user can proceed with the registration process and gain full ownership of the domain.
Inactive Domain Restoration: If a registered domain remains unused for an extended period, the system may initiate a process to restore the domain to the available pool of resources. The user will be notified and given a certain period to respond and demonstrate usage or intent to use the domain.
User Notification: If the user fails to respond or show intent to use the domain within the specified time, the domain is returned to the available resource pool, allowing others to register it.

This process aims to balance the interests of trademark holders, domain name registrants, and the broader community while leveraging the decentralized nature of the DNS system to ensure fair and transparent outcomes.

### 2.4. Multi Languages Support

Supporting multiple languages and different scripts in the Global Chatbot Registry and Voice Browser is essential to accommodate various languages to create a truly global system. To handle language support and potential conflicts, the following features may be included.
Unicode support: Ensure that the Global Chatbot Registry and Voice Browser support Unicode, allowing the registration and handling of chatbot names in various languages and scripts, including Latin, Chinese, Japanese, and more.
Language-specific namespaces: Implement language-specific namespaces for chatbot names to avoid conflicts and ambiguities between different languages. For example, you could use a structure like “langcode: chatbottname” (e.g., “en: WeatherBot,” “zh: [symbol] ”.
Phonetic comparison across languages: Develop algorithms that can compare the phonetics of chatbot names across different languages to identify potential conflicts. These algorithms should consider pronunciation variations and similarities in different languages.
Multi-language chatbot registration: Encourage chatbot developers to register their chatbots in multiple languages if they want to support users speaking different languages. This can help ensure that users can access the chatbot using their preferred language and minimize confusion.
Language detection and user preferences: Enable the Voice Browser to detect the user's language automatically or allow users to set their preferred language. This can help ensure that the browser interacts with the Global Chatbot Registry using the appropriate language and accesses the correct chatbot names.
Dispute resolution process: Establish a dispute resolution process for cases where chatbot names in different languages conflict or create confusion. This process should involve human intervention to review and resolve the issue fairly.
By implementing these measures, the Global Chatbot Registry and Voice Browser can better support multiple languages and scripts, ensuring a more inclusive and accessible system for users worldwide.

### Module 3-Open Chatbot Browser

A chatbot browser for interacting with open chatbots using commands. The chatbot browser includes a nature language recognition module, a chatbot communication module, and a user interface module. The interface might be only voice, not necessary should be a touch screen.

The chatbot browser is a software application designed for IoT devices that allows users to interact with open chatbots using voice commands. The chatbot browser includes a voice recognition module for converting spoken commands into text, a chatbot communication module for interacting with open chatbots using the chatbot communication protocol, and a user interface module for providing a touch screen display and touch-based interaction.

The voice recognition module includes a natural language processing engine for analyzing spoken commands and extracting relevant information, such as the chatbot name or command keywords. The chatbot communication module uses the chatbot communication protocol to exchange messages with open chatbots and retrieve responses.

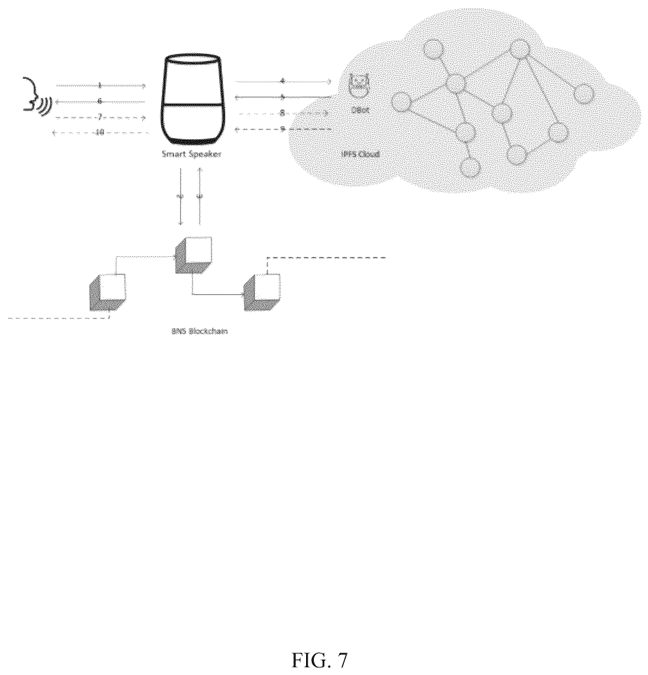

FIG. 7 shows a sample user interaction flow.

### 3.1. Voice Enabled Feature for Voice Enable Devices

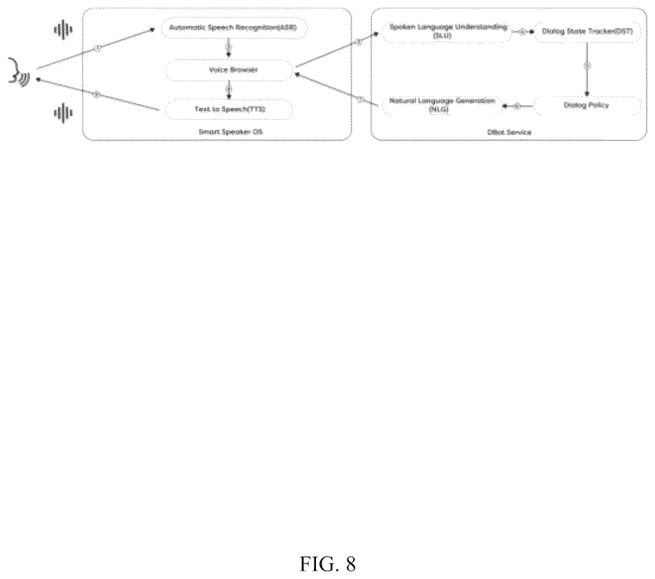

The chatbot browser can be installed on a wide range of IoT devices, including smart speakers, smart home appliances, and wearable devices. To develop a Chatbot browser for interacting with chatbots, a system architecture that can support voice recognition, natural language processing, chatbot management, and easy integration with IoT devices. FIG. 8 shows a high-level overview of the architecture and the required modules.

Here's a high-level overview of the architecture and the required modules:
Voice Recognition Module: This module is responsible for converting the user's speech into text. It should support various languages and dialects for broad accessibility. You may consider using open-source libraries like Mozilla's Deep Speech or Google's Speech-to-Text API for this purpose.
Natural Language Processing (NLP) Module: This module interprets the user's text input and determines the appropriate action or command, such as redirecting to another chatbot or executing specific functions. Pre-trained LLM models should be deployed on it.
Browser Management Module. People can manage the browser. Setting feature should be provided.
Text-to-Speech Module: This module converts the chatbot's text response into speech, allowing the user to listen to the response. Like the voice recognition module, it should support multiple languages and dialects. Open-source libraries like Google's Text-to-Speech API, Festival, or speak could be used for this purpose.
IoT Device Integration Module: This module facilitates the integration of the Chatbot browser with various IoT devices. It should be designed to support different platforms and operating systems, ensuring compatibility with a wide range of smart devices.

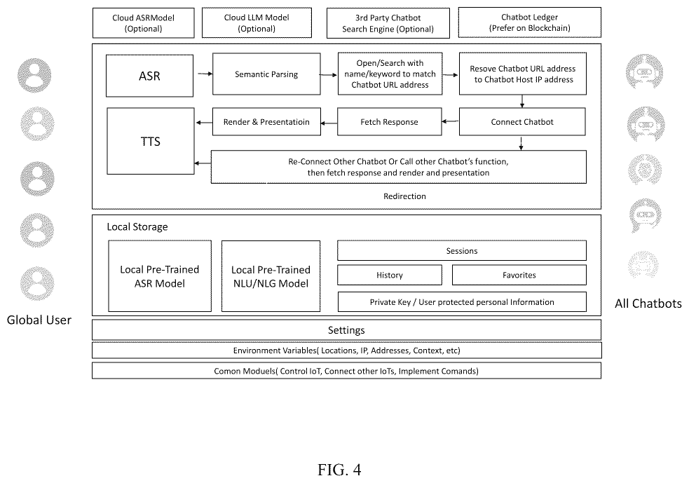

FIG. 4 shows a high-level chart of the architecture.

### 3.2. Interaction Between IoT Devices and Chatbot Browser

For the Global Chatbot Registry system, you can use a decentralized storage solution that may leverage blockchain technology. This ensures that the registry is secure, reliable, and resistant to censorship or manipulation. The data can be stored across multiple nodes in a distributed network, ensuring high availability and fault tolerance. As for the interaction between the Chatbot browser embedded in IoT devices and the Global Chatbot Registry, you can follow these steps:
The IoT device's Chatbot browser sends a request to the registry when a user wants to interact with a specific chatbot. This request can include the chatbot's name or any relevant identifier.
The registry looks up the chatbot's information, such as its IP/URL address and any metadata, in the decentralized storage.
Once the registry finds the chatbot's information, it sends the URL address back to the Chatbot browser.
The Chatbot browser then establishes a secure connection with the chatbot using the provided URL address and the Chatbot Communication Protocol.
The user can now interact with the chatbot using voice commands, and the IoT device's Chatbot browser facilitates the conversation.

For efficient interaction between the Chatbot browser and the Global Chatbot Registry, it implements a lightweight client within the browser to handle communication with the registry. This client can handle data retrieval and updates from the registry, as well as cache frequently accessed chatbot information for faster access. To find the most reliable nodes for interaction, the Chatbot browser can employ a combination of strategies to ensure optimal performance and reliability. some methods to achieve this:
Node discovery: The browser can utilize a decentralized node discovery mechanism to find and maintain a list of active nodes in the network.
Node performance monitoring: The browser can track the performance and reliability of the nodes it interacts with by measuring factors such as response time, uptime, and data consistency. By continuously monitoring node performance, the browser can identify the most reliable nodes and prioritize communication with them.
Geolocation-based node selection: The browser can use geolocation data to select nodes that are geographically closer to the user's location. This can help reduce latency and improve the overall user experience.
Load balancing: To distribute the workload evenly across the available nodes, the browser can implement load balancing strategies. This helps prevent overloading individual nodes and ensures that the system remains responsive even under high traffic conditions.
Automatic node switching: In case a node becomes unresponsive, or its performance degrades, the browser can automatically switch to another reliable node from its list. This ensures that the user's interaction with the chatbot is not interrupted due to node issues.
Caching: The browser can cache frequently accessed data locally, reducing the need to constantly fetch information from the nodes. This can help speed up interactions with the chatbot registry and reduce the load on the network.

By employing these strategies, the Chatbot browser can discover and maintain a list of reliable nodes, prioritize communication with high-performing nodes, and ensure an optimal user experience when interacting with chatbots through the Global Chatbot Registry.

Redirecting to a search engine could be a viable option when the Voice Browser is unable to handle the voice commands or when there is ambiguity with the chatbot names. Here is how it could work:
The Voice Browser receives a voice command that it cannot understand or is ambiguous.
The Voice Browser recognizes the need for a search and redirects the user to a search engine that supports voice input.
The search engine uses speech recognition and natural language processing to understand the user's voice input and returns a list of relevant chatbots that match the user's request.

The search engine lists the chatbots along with their names, descriptions, and other relevant information. The user can select a chatbot by saying its name or number, which is recognized by the search engine using speech recognition. If there is still ambiguity, the search engine could provide additional options or ask for more information from the user. Once the user selects a chatbot, the search engine provides the Chatbot Browser with the chatbot's URL, which the Voice Browser uses to initiate the conversation with the chatbot. Overall, this approach could help resolve issues with ambiguous or unrecognized voice commands and provide users with a more seamless and efficient voice-based experience.

Module 4-Semantic Module in the browser or device.

This module is able to use LLM deployed locally to better understand user's intent, then try to find a proper chatbot. It can also ask the search engine's help, just like traditional browsers.

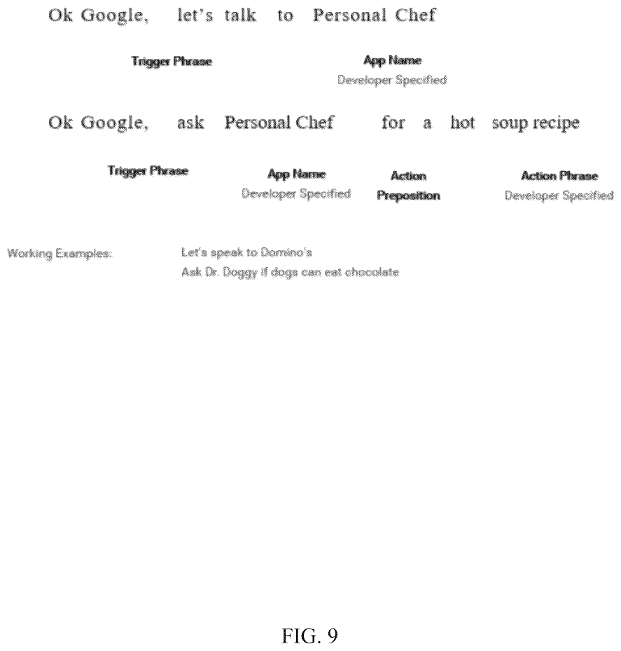

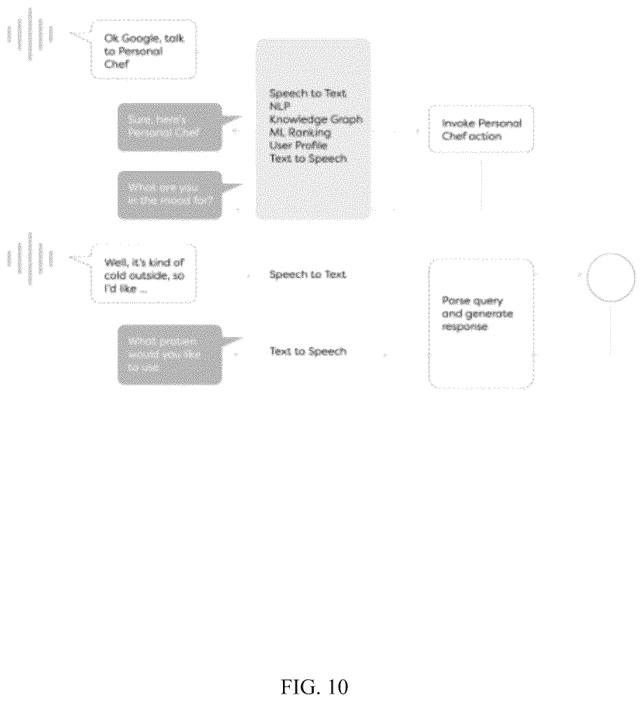

FIGS. 9-10 shows how the process works. Because the Chef chatbot is registered on global open ledger, the browser needs to fetch its address first, then make connection and call its function. By this means, the Google now is a kind of browser, that connects to open chatbot ledger. Itself will not send data to its server, when do Natural Language Understanding (NLU) and Natural Language Generation (NLG), it can use its local deployed LLM models.

### Module 5-Protocols

### 5.1 Chatbot Name Resolving Protocol

While each of these platforms has its challenges, they still offer potential foundations for a global chatbot registry. It's important to weigh these limitations against the benefits of each platform and consider how they align with your project's goals and requirements.

Here's a description of the steps in the chart:
The user speaks in the Voice Browser and says “@chatgpt” or requests to transfer to a specific chatbot, such as “@chatgpt.”
The Voice Browser sends a request to the Global Chatbot Registry, which looks up the chatbot's information in the decentralized storage.
The registry finds the chatbot's URL address (IP or traditional URL) and sends it back to the Voice Browser.
The Voice Browser establishes a secure connection with the chatbot using the provided URL/IP address and the chosen Chatbot Communication Protocol (MQTT, CoAP, HTTP, etc.). The browser then redirects the user to the chatbot and handles the conversation.

This chart illustrates the process of resolving a chatbot's address in the Global Chatbot Registry and redirecting the user to the desired chatbot through the Voice Browser. The Chatbot Communication Protocol itself doesn't handle user registration, as its primary purpose is to facilitate communication between the Chatbot browser and Open Chatbots. However, user registration and authentication can be integrated into the Chatbot browser, which interacts with the chatbots.

Here's a potential approach to implementing user registration and authentication in the Chatbot browser:

### 5.2 Chatbot Hyperlink Protocol

A protocol for enabling hyperlinks within chatbot conversations, including support for linking to other chatbots, smart IoT devices, and internet web services. The protocol enables chatbots to interact with other chatbots and devices, control smart devices, and access web services using hyperlinks embedded within chatbot conversations.

The Chatbot Hyperlink Protocol enables hyperlinks within chatbot conversations, allowing users to interact with other chatbots, smart IoT devices, and internet web services using natural language-based commands. The protocol includes the following components:
A hyperlink format for embedding hyperlinks within chatbot conversations. The hyperlink format can include metadata related to the linked resource, such as resource type, name, and location.
A hyperlink resolver for resolving hyperlinks and facilitating navigation to the linked resource. The hyperlink resolver can use various techniques to identify the linked resource, such as searching the global chatbot registry, querying smart IoT devices, and accessing web services.
A hyperlink handler for processing hyperlinks and executing the corresponding action. The hyperlink handler can interpret the metadata associated with the hyperlink and take appropriate action based on the linked resource type, such as invoking a chatbot API, sending a command to a smart IoT device, or accessing a web service.

The Chatbot Hyperlink Protocol enables chatbots to interact with other chatbots and devices, control smart devices, and access web services using hyperlinks embedded within chatbot conversations. This enhances the user experience by providing a convenient and intuitive way to access various resources using natural language-based commands. Usually, the hyperlinks is not used for users to click, which is a kind of functions that can be called by the browser. Redirect talk between the browser chatbot to other chatbot, is one kind of scenery, the hyperlinked functions call be called by the browser as well.

### 5.3 Chatbot Communication Protocol

A chatbot communication protocol for facilitating communication between chatbot browsers and chatbots, comprising: A standardized format for chatbot APIs, message exchange formats, and error handling. Rules and guidelines for chatbot developers to follow when developing their chatbots to ensure interoperability with chatbot browsers. Support for multiple languages and chatbot platforms. Support for multimedia content, such as images and videos, and hyperlinked HTML documents; and Robust error handling mechanisms to ensure reliable communication between chatbot browsers and chatbots. Because of bandwidth, CPU, and power consumption, a lightweight messaging protocols such as MQTT and CoAP protocols might be considered. As the environment matures and the need for more complex interactions arises, transitioning to HTTP or incorporating elements of HTTP-based communication may become necessary.

Although the invention has been explained in relation to its preferred embodiment, it is to be understood that many other possible modifications and variations can be made without departing from the spirit and scope of the invention as hereinafter claimed. It is to be understood that the steps may be performed in any order without departing from the spirit and scope of the invention.

What is claimed is:

1. A system for enabling a user to interact with a plurality of chatbots and a plurality of resources using a chatbot browser, comprising:
a global open chatbot registry configured for registering and managing chatbots;
an open chatbot browser configured for finding and browsing the plurality of chatbots and configured for talking to the plurality of chatbots; and
a chatbot protocol configured for facilitating communication between the chatbot browser and the plurality of chatbots.

2. The system of claim 1, wherein the chatbot browser can be installed on any computer, mobile phone, wearable devices, or any suitable voice first devices.

3. The system of claim 1, wherein:
the chatbot communication protocol supports a plurality of chatbot APIs; and
the chatbot communication protocol adapts to new APIs as they are developed.

4. The system of claim 1, wherein a semantic module uses NLU to analyze a chatbot of the plurality of chatbots to which to redirect the user.

5. A method for enabling a user to interact with a plurality of chatbots and a plurality of other resources, comprising the steps of:
registering and managing the plurality of chatbots in a global chatbot registry; and
facilitating communication between an internet browser and the plurality of chatbots using a chatbot communication protocol.
